(19) United States
(12) Patent Application Publication
(10) Pub. No.: US 2010/0223147 A1
(43) Pub. Date: Sep. 2, 2010

(54) COMMODITY SETTLEMENT SYSTEM, METHOD THEREFOR AND MOBIL TERMINAL

(75) Inventor: Sadatoshi Oishi, Shizuoka-ken (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/710,826

(22) Filed: Feb. 23, 2010

(30) Foreign Application Priority Data
Mar. 2, 2009 (JP) 2009-48343
Mar. 2, 2009 (JP) 2009-48345
Jun. 2, 2009 (JP) 2009-132622

(51) Int. Cl. G06Q 30/00; G06K 15/00; G06Q 10/00

(52) U.S. Cl. 705/23; 235/383

(57) ABSTRACT

A commodity settlement system processes settlement for a commodity carrying an RF tag, communicating with the RF tag for data associated with the commodity stored in an RF tag. The RF tag comprises a capacitor, a memory, and an antenna, the RF tag being capable of receiving a radiowave from an external device, charges the capacitor with a direct current converted by the rectifier circuit from a current induced in the antenna by receiving a radiowave from an external device, and stores temporary settlement information in the memory. The commodity settlement system includes a first RF tag reader/writer connected to an antenna disposed on a commodity shelf. The first RF tag reader/writer sets the temporary settlement information in the memory to an “unsettled” state through the antenna disposed on the commodity shelf at intervals of a predetermined time.

### CROSS REFERENCE TO RELATED APPLICATIONS

This application is based upon and claims the benefit of priority from the prior Japanese Patent Applications No. 2009-48345 filed on Mar. 2, 2009, No. 2009-48343 filed on Mar. 2, 2009, and No. 2009-132622 filed on Jun. 2, 2009, the entire contents of which are incorporated herein by reference.

### BACKGROUND

1. Technical Field

Described herein relates to a commodity settlement system used in retail stores or the like. Described herein specifically relates to a commodity settlement system that reads a commodity code from an RF tag (RFID or Radio Frequency Identification tag) attached to a commodity, and processes commodity sales data based on the commodity codes having been read. Described herein also relates to a mobile terminal used in the commodity settlement system and a commodity settlement method thereof.

2. Description of the Related Art

In general merchandising stores such as a supermarket, commodity containers such as a shopping basket and a shopping cart are provided for customers. An incoming customer goes around in a store carrying a shopping basket or moving a shopping cart, collectively puts purchasing commodities into the shopping basket or shopping cart, and carries them to a checkout counter. There is provided at the checkout counter a settlement apparatus called a POS (Point Of Sales) terminal mounting a barcode reader. A store clerk (cashier) picks up the commodities contained in the commodity container one by one and inputs commodity information into the settlement apparatus by having the barcode attached to a commodity read by the barcode reader. When inputting all the information of the commodities contained in the commodity container is completed, the total amount is displayed on a display section of the settlement apparatus. The store clerk informs the customer of the total amount, and the customer pays for the purchasing commodity or commodities and receives a receipt.

Such a method of inputting commodity information to the settlement apparatus while picking up commodities one by one from the commodity container involves problems that inputting commodity information takes a time, and therefore a degree of fatigue builds up on store clerks engaging in such a work.

To solve the above problems, there has been proposed a settlement apparatus as disclosed in Japanese laid-open patent application No. 10-49756, in which an RF tag reading apparatus (RF tag reader) is provided to read a data from an RF tag. Such an RF tag storing commodity ID code, etc. as data, which is specific to each commodity, is attached to individual commodities. The RF tag, incorporating a memory, an antenna, a transmitting and receiving circuit, etc., wirelessly transmits the data (commodity ID code) in the memory tuning in an external electromagnetic wave. The RF tag reader inquires the RF tag for the memory data transmitting the electromagnetic wave that the RF tag tunes in and acquires the memory data from an electromagnetic wave transmitted by the relative RF tag. The RF tag reader is connected with an antenna that transmits and receives an electromagnetic wave. The antenna connected with the RF tag reader is formed in a shape of a tunnel, through which a commodity container passes so that the antenna is oriented in all directions of the commodity container.

At check counter a store clerk causes the RF tag reader to collectively read commodity ID codes of commodities of one customer from the memories of the respective RF tags without taking out the commodities from the commodity container, so that the clerk can input the commodity ID codes into the settlement apparatus. Therefore, the operating time of the clerk of inputting the data into the settlement apparatus can be reduced and clerk's workload can be thereby alleviated.

On the other hand, when an aluminum-evaporated-foil wrapped cakes or steel-canned commodity of juice or alcohols exist near the RF tag, the antenna of the RF tag cannot sometimes normally function and therefore the reception power of the RF tag drops. Therefore, there arises a problem that the RF tag reader cannot read all of the RF tags within the commodity container.

Japanese laid-open patent application No. 2006-166415 discloses a high-gain rectifier circuit and an RF tag using the circuit as a high sensitive RF tag that is improved so that the RF tag can operate even if reception power of the RF tag drops.

In conventional commodity settlement systems using an RF tag and an RF tag reader, an antenna of the RF tag reader needed to be provided in a checkout counter in a shape of a tunnel that allows a commodity container to pass through it so that the antenna can be oriented in all directions of the commodity container. Therein, a problem occurred that, if the antenna is formed in a tunnel, the large area is required for the facility. In addition, since store clerks are required to let the commodity container pass through the tunnel, a hard work is obliged. In this case, it is possible that a conveyer belt is provided at the checkout counter so that the commodity container can be automatically passed through the tunnel. However, this required an even larger facility area at the checkout counter.

### SUMMARY

Accordingly, an aspect of the embodiment is to provide a commodity settlement system capable of inputting commodity information of commodities that a customer purchases into a settlement apparatus using an RF tag without the need of acquiring a large facility area.

According to the embodiment, there is provided a commodity settlement system for making settlement for one or more commodities each carrying an RF tag displayed on a commodity shelf, comprising:

an RF tag attached to the commodity, comprising a capacitor, a rectifier circuit, a memory, and an antenna, the RF tag being provided to charge the capacitor with a direct current converted by the rectifier circuit from a current induced in the antenna by receiving a radiowave from an external device, the RF tag storing settlement information in the memory; a communication device receiving a data associated with each commodity stored in the RF tag; and a first RF tag reader/writer connected to an antenna provided on the commodity shelf, for setting settlement information in the memory to information in an unsettled state through the antenna at intervals of a predetermined time.

### BRIEF DESCRIPTION OF THE DRAWINGS

These and other objects and advantages of the embodiment will become apparent and more readily appreciated from the following detailed description taken in conjunction with the accompanying drawings wherein:

FIG. 1 is a view of a commodity shelf used in a commodity settlement system;

FIG. 2 is a structural diagram of the commodity settlement system;

FIG. 3 is a structural diagram of a mobile terminal;

FIG. 4 is a structural diagram of a checkout machine in the commodity settlement system;

FIG. 5 is a structural diagram of an alarm-equipped gate in the commodity settlement system;

FIG. 6 is a structural diagram of an RF tag;

FIG. 7 is another structural diagram of an RF tag;

FIG. 8 shows a memory map within the RF tag; and

FIG. 9 is a flowchart illustrating the operations of the mobile terminal.

### DETAILED DESCRIPTION

Embodiments will now be described in more detail with reference to the accompanying drawings. However, the same numerals are applied to the similar elements in the drawings, and therefore, the detailed descriptions thereof are not repeated.

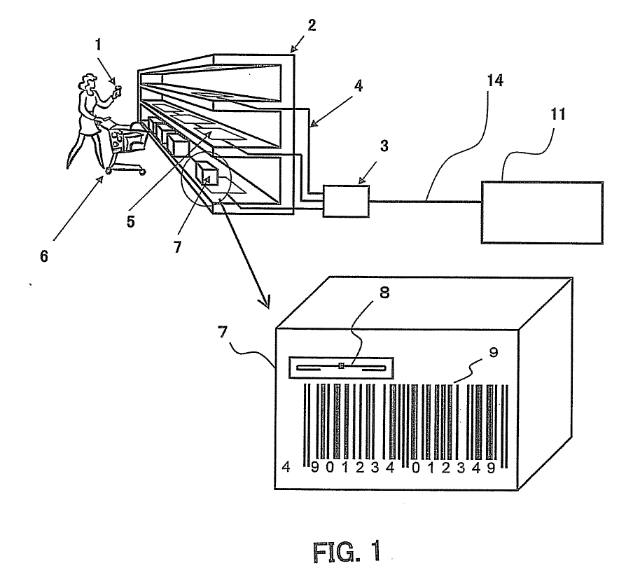

FIG. 1 illustrates a commodity shelf used in a commodity settlement system. There are provided more than one shelf antenna 5 on each shelf board of a commodity shelf 2, the more than one shelf antenna being interconnected in series by a coaxial cable 4. An RF tag reader/writer 3 is connected to shelf antennas S with coaxial cable 4. RF tag reader/writer 3 is also connected to a server 11 through network cable 14. Commodities 7, to each of which an RF tag 8 (RFID—Radio Frequency Identification) and a barcode 9 are attached, are arranged on a commodity shelf 2. A customer goes around in a store carrying a shopping basket or moving a shopping cart (commodity container) 6, puts commodities 7 to be purchased into shopping cart 6, and carries them to a checkout counter. The system is configured so that a customer can achieve a settlement process in a short time by using a mobile terminal 1, which will be described later.

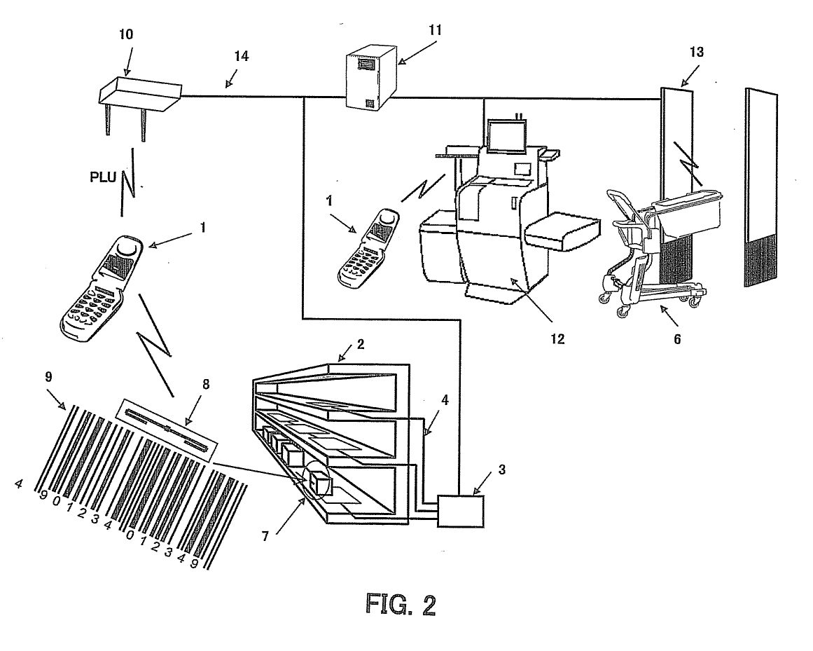

FIG. 2 shows a structure of the commodity settlement system. An access point 10, a checkout machine 12, and an alarm-equipped gate 13 are connected to server 11 by network cable 14. Mobile terminal 1, comprising a barcode reader, an RF tag reader/writer (a device that writes and reads data to/from the RF tag), and a display device displaying data, communicates with server 11 via access point 10. Mobile terminal 1 transmits and receives data to/from access point 10 using a wireless LAN (Local Area Network). The use can be made of wireless communication between adjacent devices using the 2.4 GHz frequency band, as another communication means. The distance between neighboring devices herein is in the order of 10 meters. The terminal can use other general communicating means.

Server 11 has a customer master file that preliminarily stores data associated with individual commodities. The commodity-associated data includes a commodity code identifying individual commodity, an attribute code denoting one of various attributes of commodities, a commodity name specifying individual commodity, and an article data such as a sales price.

When a customer inputs a commodity code by the barcode reader of mobile terminal 1, data such as a commodity name and sale price identified by this commodity code are retrieved from the master file in server 11. These data are transmitted to mobile terminal 1 through access point 10. Mobile terminal 1 then displays the commodity-associated data, i.e. a price and a commodity name, informing the customer of the data.

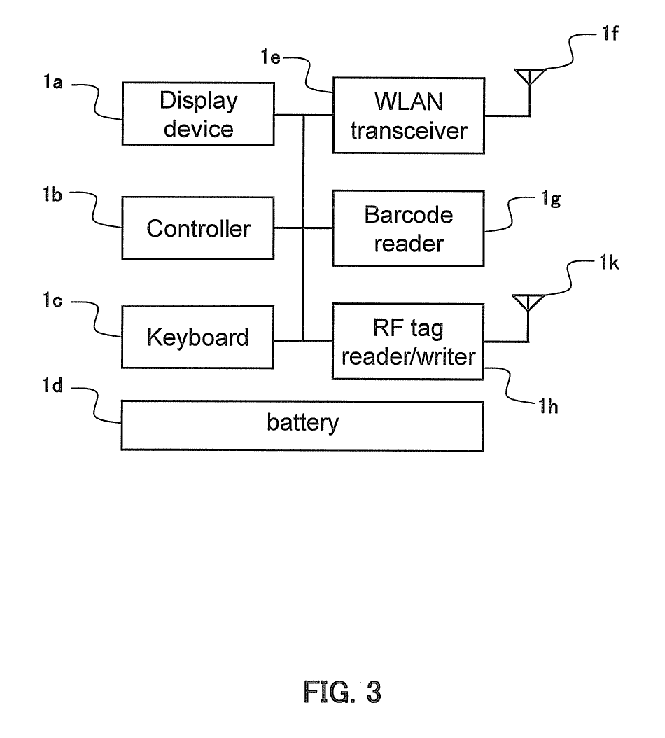

FIG. 3 shows a structure of mobile terminal 1. Mobile terminal 1 comprises a display device 1a displaying the commodity-associated data, a keyboard 1c inputting data to the mobile terminal, a WLAN transceiver 1e (Wireless Local Area Network Transceiver) as a wireless communication means for communicating with server 11 through access point 10, an RF tag reader/writer 1h data-communicating with the RF tag attached to a commodity, a barcode reader 1g reading a barcode affixed to a commodity, a controller 1b controlling these devices, and a battery 1d for supplying a power to operate mobile terminal 1. Display device 1a, keyboard 1c, WLAN transceiver 1e, RF tag reader/writer 1h (RFID reader/writer), and barcode reader 1g are connected to controller 1b that controls the operations of mobile terminal 1. WLAN transceiver 1e is connected to an antenna 1f trough which the WLAN transceiver data-communicates with access point 10. RF tag reader/writer 1h is connected to an antenna 1k through which the RF tag reader/writer data-communicates with RF tag 8 attached to a commodity. Mobile terminal 1 is linked to access point 10 through antenna 1f by WLAN transceiver 1e, enabling the terminal to communicate with server 11.

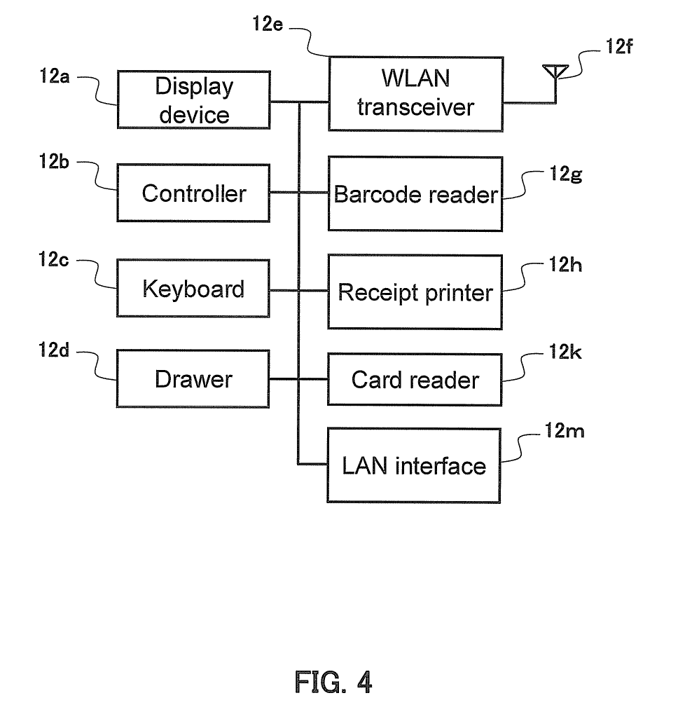

FIG. 4 shows a structure of checkout machine 12. Checkout machine 12 is a POS terminal, which is one aspect of a commodity sales data processing apparatus. Checkout machine 12 incorporates a CPU (Central Processing Unit) as a main controller 12b. Checkout machine 12 comprises a ROM (Read Only Memory) that preliminarily stores fixed data including programs, a RAM (Random Access Memory) that forms various data areas to store variable data such as input data and arithmetic processing data, a clock section keeping a current time, a LAN interface 12m (local Area Network Interface) controlling the data communication with store server 11 being connected online. WLAN transceiver 12e is connected to an antenna 12f, communicating with mobile terminal 1 and RF tag 8 for data. Furthermore, checkout machine 12 comprises an I/O (Input Output) port outputting the respective signals to devices of a keyboard controller, first and second display controllers, a printer controller, a drawer 12d, a card reader 12k, and a buzzer. The keyboard controller takes in key signals corresponding to the respective operation keys of keyboard 12c. The first display controller controls a screen display on operator's display device 12a. The second display controller controls a screen display on a customer's screen display device. The printer controller controls operations of a receipt printer 12h that prints on a receipt. Drawer 12d is a cash receiving device for containing cash. Card reader 12k reads or writes data of a magnetic card. The buzzer makes an electronic sound notifying that data has been read. CPU, ROM, RAM, clock section, LAN interface 12m, WLAN transceiver 12e, I/O port, and controller for various input/output devices are interconnected through bus lines including an address bus and a data bus.

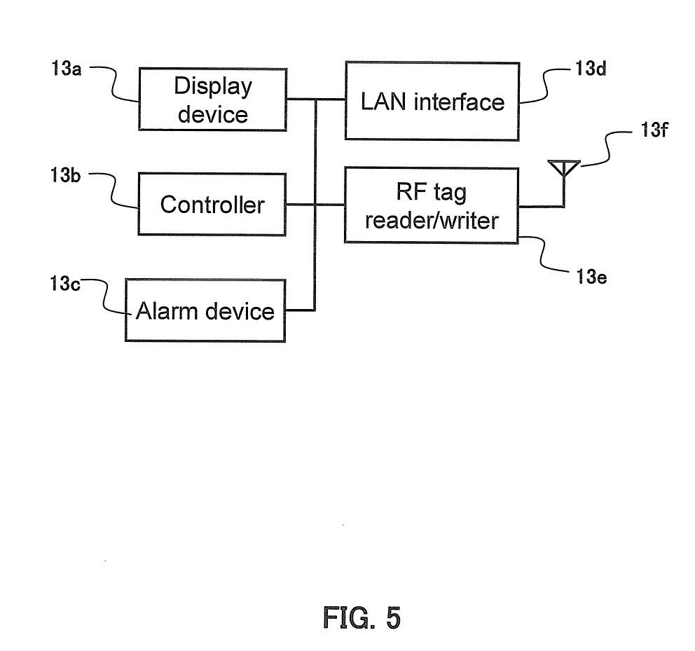

FIG. 5 shows a structure of alarm-equipped gate 13. Alarm-equipped gate 13 utters an alarm sound, for example, when commodity 7 is taken out of a store without paying for it, so that shoplifting of commodity 7 can be prevented. Alarm-equipped gate 13 comprises a display device 13a, a controller 13b, an alarm device 13c, a LAN interface 13d, and an RF tag reader/writer 13e that can read memory information of commodity RF tag 8 attached to commodity 7. An antenna 13f connected to this RF tag reader/writer 13e is provided at a store exit. RF tag reader/writer 13e reads memory information of commodity RF tag 8 attached to commodity 7 that is carried by a customer who is going out from the store exit. Antenna 13f is provided within a gate, as illustrated in FIG. 2, through which a shopping cart carrying commodities passes. If the detection is made that the memory has not been recorded in a state of being “settled,” alarm device 13c sounds a red alert, warning that the commodity or commodities are possibly shoplifted. Moreover, the system is so structured that RF tag reader/writer 13e provided within alarm-equipped gate 13 can discharge the power charged in a capacitor of RF tag 8 attached to the commodity.

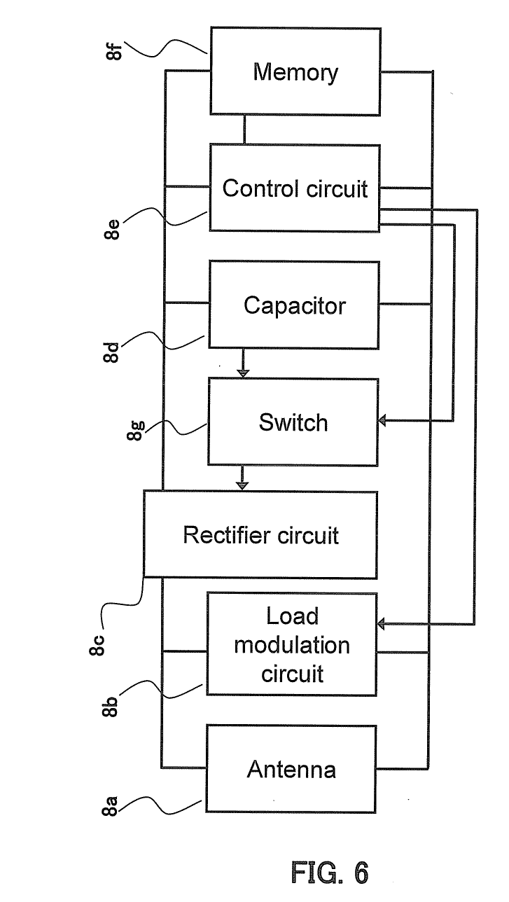

FIG. 6 shows a structure of RF tag 8. RF tag 8 comprises an antenna 8a, a load modulation circuit 8b, a rectifier circuit 8c, a capacitor 8d, a control circuit 8e, a memory 8f, and a switch 8g that turns on and off capacitor 8d. Control circuit 8e controls load modulation circuit 8b and switch 8g. When RF tag 8 responds according to a data stored in memory 8f, load modulation circuit 8b generates a backscatter signal, which is a responsive signal to RF tag reader/writer 3 and mobile terminal 1, by changing a load according to the data signal. Switch 8g switches capacitor 8d between states of being “charged” and “discharged.” When capacitor 8d is in a state of being “charged,” the sensitivity of the RF tag increases. In this state, RF tag 8 generates the backscatter signal in response to the radiowave from RF tag reader/writer 1h of mobile terminal 1. When the power in the capacitor 8d is discharged, the sensitivity of RF tag 8 drops so that RF tag 8 becomes disabled to respond to the radiowave from the RF tag reader/writer.

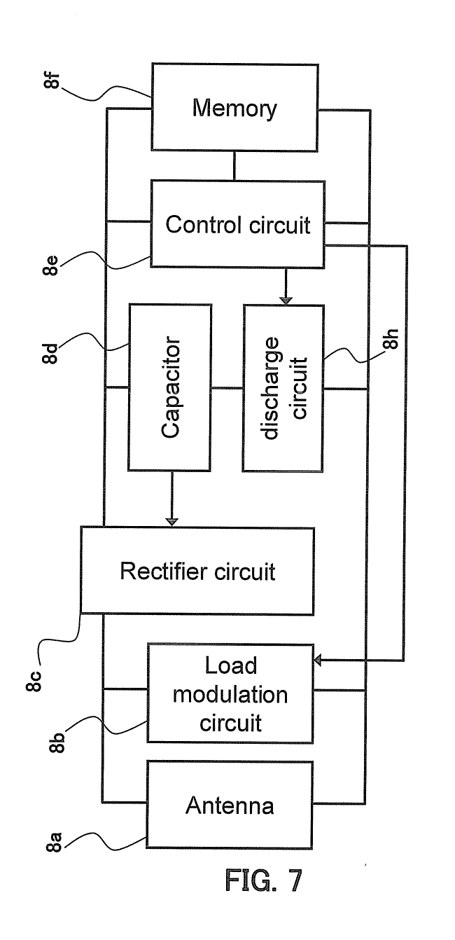

FIG. 7 shows another embodiment of RF tag 8. In this embodiment, RF tag 8 comprises antenna 8a, load modulation circuit 8b, rectifier circuit 8c, capacitor 8d, control circuit 8e, memory 8f, and a discharge circuit 8h that discharges the power in capacitor 8d. Normally, with capacitor 8d in the state of being “charged,” the receiver sensitivity of RF tag 8 increases. In this state, RF tag 8 generates the backscatter signal in response to the radiowave from RF tag reader/writer 1h of mobile terminal 1. When the power in the capacitor is discharged, the sensitivity of RF tag 8 drops so that RF tag 8 becomes disabled to respond to the radiowave from the RF tag reader/writer.

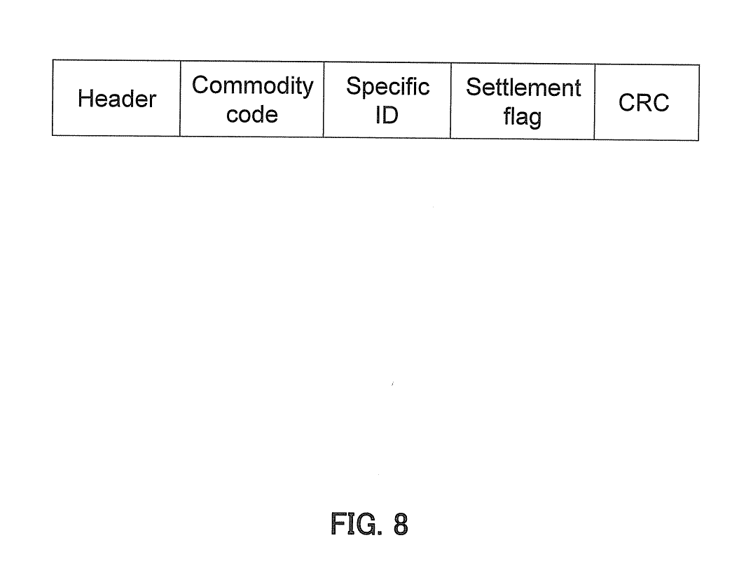

FIG. 8 is a memory map within RF tag 8. A “header” denotes a head of data. A “commodity code” represents a name of individual commodity. A “specific ID” is a specific identification number assigned to individual commodity. A “settlement flag” representing settlement information indicates three states of a commodity, that is, a state of being “temporarily settled,” being “unsettled,” or being “settled.” A customer picks up commodity 7 from commodity shelf 2 and makes mobile terminal 1 read (scan) barcode 9. Then, RF tag reader/writer 1h incorporated in mobile terminal 1 sets the settlement flag of RF tag 8 into the state of being “temporarily settled.” When the customer returned commodity 7 to the commodity shelf 2, RF tag reader/writer 3 of commodity shelf 2 rewrites reinitializes the flag into the state of being “unsettled.” In this manner, the settlement information is revised into the state of being “temporarily settled” or “unsettled.”

Now, a description will be made for operations of RF tag 8. RF tag reader/writer 3 periodically transmits a continuous-wave and a signal from shelf antenna 5. When commodity 7 carrying the RF tag 8 is disposed on the commodity shelf 2, the continuous-wave and signal transmitted from RF tag reader/writer 3 periodically resets the settlement information within the memory of RF tag 8 to the state of being “unsettled.” Since RF tag 8 is positioned in the proximity of shelf antenna 5, RF tag 8 exists within the intense field intensity area where the radiowave is continuously radiated from shelf antenna 5.

The high-frequency power received by antenna 8a of RF tag 8 is converted into a DC current in rectifier circuit 8c and charged in capacitor 8d. As rectifier circuit 8c is biased by capacitor 8d and its rectifying sensitivity is boosted, the receiver sensitivity of RF tag 8 increases. When a customer takes commodity 7 that he or she wishes to purchase from commodity shelf 2, RF tag 8 attached to the commodity exits from the intense field intensity area where the radiowave is radiated from RF tag reader/writer 3. Even though RF tag 8 exits from the intense field intensity area, because rectifier circuit 8c keeps the high sensitivity by capacitor 8d, RF tag 8 can hold the high sensitivity state for several hours.

A description will be made for a procedure of the commodity registration in this commodity settlement system.

When a store clerk displays commodity 7 to which RF tag 8 and barcode 9 are attached on commodity shelf 2 in a store, the RF tag 8 periodically receives the continuous-wave and signal transmitted through shelf antenna 5. The signal contains a command to reset the settlement information retained within the memory of the relative RF tag 8 to the “unsettled” state. Thus, the settlement information in all the commodities on the shelf is automatically reset to the “unsettled” state. Thereafter, the settlement information in all the commodities on the shelf antenna 5 is automatically reiteratively reset to the “unsettled” state.

A customer walks around in a store pushing shopping cart 6 with a shopping basket in the cart looking for commodity 7 to be purchased. He or she also carries mobile terminal 1 while walking in the store. When the customer finds a desired commodity 7, he or she causes that RF tag 8 attached to commodity 7 to be set to “temporarily settled” state using mobile terminal 1.

If the store carries mobile terminal 1, the store lends the customer mobile terminal 1. Mobile terminal 1 is used during shopping for the customer to set temporary settlement information of commodity 7 that the customer wishes to purchase. Some customers carry their own mobile terminal 1. This applies the case, for example, where a cell-phone carried by a customer has the same functions as mobile terminal 1 that the store provides.

Barcode 9 and RF tag 8 are normally attached to commodity 7. However, it is assumed that in some cases not all of the commodities 7 in a store may carry RF tag 8. For this reason, the customer causes barcode 9 of a commodity to be read by barcode reader 1g of mobile terminal 1 after he or she chooses a commodity before putting it into the shopping basket. At the same time, RF tag reader/writer 1h of mobile terminal 1 reads the commodity code in memory 8f of RF tag 8 attached to commodity 7, sets the settlement information of the settlement flag to “temporarily settled” state (refer to FIG. 8). To avoid RF tag reader/writer 1h accidentally revising settlement information of RF tag 8 in the neighboring commodity, setting of settlement information of RF tag 8 is executed only when a commodity code of barcode 9 read by barcode reader 1g conforms to the commodity code of the corresponding RF tag 8.

If commodity 7 has only barcode 9 thereto without RF tag 8 attached thereto, only that barcode 9 can be read. That is, if RF tag reader/writer 1h could not read commodity code of RF tag 8, only reading of barcode 9 is to be valid.

Controller 1b of mobile terminal 1 that has recognized a commodity code of barcode 9 wirelessly connects to access point 10 by WLAN transceiver 1e through antenna 1f. Controller 1b enquires server 11 for a commodity name and a price related to the commodity through access point 10. The commodity name and price information returned from server 11 are stored in controller 1b through access point 10 and WLAN transceiver 1e, and displayed on display device 1a. Acquiring a commodity name and a commodity price by enquiring the server is called “PLU (Price Look Up).” Controller 1b stores all commodity information (commodity codes) related to the commodities picked up from commodity shelf 2 in the memory provided in mobile terminal 1. Since commodity names, prices, and total amount of all the commodities contained in shopping cart 6 are displayed on display device 1a of mobile terminal 1, the customer can know the total amount so far in the middle of the shopping.

There may be such a case that a customer stops a purchase of a commodity after the RF tag reader/writer has set the settlement flag into the temporarily settled state. When such a customer returns the “temporarily settled” commodity 7 to commodity shelf 2, the customer causes barcode 9 of the relative commodity 7 to be read by barcode reader 1g of mobile terminal 1 to cancel the commodity information in mobile terminal 1 related to the returned commodity. With the “temporarily settled” commodity 7 returned to commodity shelf 2, the temporary settlement information in the memory of the relative RF tag 8 is reset to the “unsettled” state by the continuous-wave and signal transmitted by RF tag reader/writer 3 through shelf antenna 5.

Next, a description will be made for the procedure of “Settlement.” The customer takes one or more commodities having them temporarily settled by mobile terminal 1, puts them into the shopping cart, and heads to checkout machine 12. The customer operates mobile terminal 1 in front of checkout machine 12 to start settlement. Mobile terminal 1 connects to access point 10 through WLAN transceiver 1e or WLAN transceiver 12f of checkout machine 12 to transfer commodity code stored in the internal memory of mobile terminal 1 to checkout machine 12. Checkout machine 12 in turn performs PLU operation according to the transferred commodity codes, acquires relative commodity names and prices from server 11, calculates the sum total, and displays it on display device 12a.

The customer puts money into drawer 12d of checkout machine 12, or pays by a credit card by passing the card through card reader 12k. Upon completion of the settlement, checkout machine 12 issues a receipt from receipt printer 12h, informs the completion of the settlement to mobile terminal 1 through WLAN transceiver 1e. Herein, the settlement information of the RF tags attached to all commodities in the shopping basket or shopping cart is set to the state of being “settled.” If mobile terminal 1 is lent from the store, the customer returns that mobile terminal 1 to the store.

Since the customer puts money in checkout machine 12 or pays by a credit card carrying a shopping cart with commodities therein to the checkout counter all by himself or herself, the work load of the store clerk in the settlement procedure can be alleviated. Some customers are served by the store clerk to pay. Even in this case, store clerk's work of carrying commodities can be saved. In addition, since commodities 7 are preliminarily paid for by the mobile terminal, the time required for the settlement can be reduced.

Next, a description will be made for a procedure of the shoplifting preventative check. When the customer passes through alarm-equipped gate 13 with shopping cart 6 mounting the shopping basket therein, alarm-equipped gate 13 sends an inquiry signal to RF tag 8 of commodity 7 through antenna 13f. Then, RF tag 8 returns only its settlement information to the gate. A period of time that customers stay within a store, that is, a period after one or more commodities are temporarily settled by mobile terminal 1 until the payment is made at checkout machine 12, is generally estimated to be within one hour. On the other hand, since the duration that capacitor 8d of RF tag 8 is designed to keep its charge for more than one hour, RF tag 8 holds the state of high receiver sensitivity during their stay in a store.

Since RF tag 8 holds the state of high receiver sensitivity, alarm-equipped gate 13 can assuredly communicate with RF tag 8, even when commodities 7 are contained at random within a shopping basket or some commodities 7 packed by an aluminum foil are mixed with others causing mismatching of antenna 8a of RF tag 8. If alarm-equipped gate 13 detects the commodity information in the state of being “unsettled,” alarm device 13c utters an electronic warning sound.

If no RF tag having its settlement information in the state of being “unsettled” or “temporarily settled” has been detected, alarm-equipped gate 13 sends a control signal to the relative RF tag 8 to turn off switch 8g of the relative RF tag 8. Control circuit 8e of the relative RF tag 8 received this signal turns off switch 8g to disable capacitor 8d so that the sensitivity of the rectifier circuit drops. That is, since the receiver sensitivity of that RF tag 8 drops, the risk that the information of that RF tag is casually read out reduces significantly.

In the structure depicted in FIG. 7, control circuit 8e of RF tag 8 controls discharge circuit 8h according to the signal transmitted by alarm-equipped gate 13 to discharge the power of capacitor 8d. As a result, the risk that the information of RF tag 8 is casually read out outside the store reduces.

Alarm-equipped gate 13 is configured so as to utter an electronic warning sound if even one commodity in the “unsettled” state is detected while reading only the settlement information of the RF tag. The commodities can be prevented from being thieved by making the warning sound. In addition, by discharging the power from the capacitor of the RF tag thereby to lower the sensitivity of the RF tag, the information of commodities that a customer purchased can be protected. Since the RF tag can hold the state of the high sensitivity by the capacitor of the RF tag for some one hour, the RF tag sensitivity lowers by the time the customer leaves the store finishing his/her shopping. Therefore, the privacy regarding purchased commodities can be protected.

A commodity settlement method in this embodiment will be described below.

A description will be made for how to set the settlement information of the RF tag to a “temporarily settled” state. Commodity shelve 2 having more than one shelf board is installed in the store. The store clerk displays on the shelf board one or more commodities 7, to each of which the aforementioned RF tag 8 and barcode 9 are attached. More than one shelf antenna 5 is provided on the respective shelf boards. RF tag reader/writer 3 is provided corresponding to commodity shelf 2 and transmits a continuous wave and a signal through shelf antennas 5. More than one antenna 5 is connected to RF tag reader/writer 3 through a coaxial cable, transmitting a continuous wave and a signal by switching the respective antennas. Capacitor 8d within RF tag 8 is charged by receiving the continuous wave transmitted. By the transmission of the signal, the temporary settlement information within the memory of RF tag 8 is initialized in the “unsettled” state. The antennas 5 provided corresponding to the respective shelf boards are sequentially operated so that the continuous wave and signal are transmitted through all the antennas 5. As a result, when a predetermined time elapses after the display of commodities 7 on commodity shelf 2, the temporary settlement information of all the commodities are automatically initialized in the “unsettled” state. Hereafter, by reiterating the transmission at predetermined intervals the temporary settlement information of all the commodities are automatically reinitialized to the “unsettled” state. The predetermined interval was defined to a time that goes through all shelf antennas 5 by sequentially driving the antennas. Needless to say, driving the antennas at intervals of an arbitrarily determined time is also possible. After the completion of the commodity settlement, the discharging from the capacitors in the RF tags is to be made.

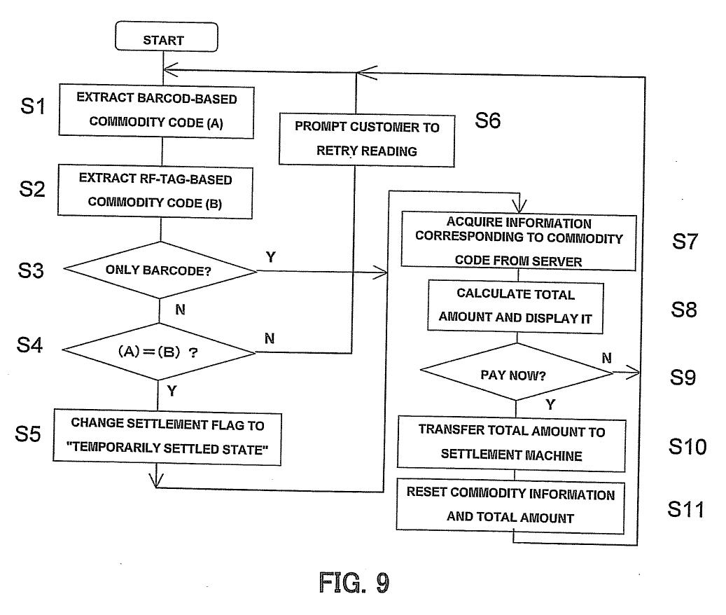

Now, the operations of mobile terminal 1 will be described in reference to the flowchart in FIG. 9. When a customer operates mobile terminal 1 to read barcode 9 of a commodity by barcode reader 1g of the terminal, a commodity code (A) is extracted from the barcode in S1. At the same time, a commodity code (B) based on the same RF tag is extracted from data of the RF tag read by RF tag reader/writer 1h provided in mobile terminal 1 in S2.

In S3, it is determined whether the commodity is accompanied only by barcode 9 or by both of barcode 9 and RF tag 8. If RF tag 8 is not attached to the commodity (if Yes), information associated with that commodity is acquired from server 11 according to commodity code (A) extracted from barcode 9 in S7. Thereafter, the customer has a total amount of the commodities processed by mobile terminal 1 calculated and displayed on the display section of mobile terminal 1 in S8. If the customer intents further purchase without preceding the final payment having an additional commodity read, the terminal stands by to read a subsequent commodity in S9. If the payment is determined in S9, when the customer carries the commodities to checkout machine 12, mobile terminal 1 transfers the total amount to checkout machine 12 by means of wireless communication in S10. When the customer completes the settlement by checkout machine 12, mobile terminal 1 is informed of the completion of the settlement from checkout machine 12 and resets the commodity information and total amount (S11). After mobile terminal 1 has reset the commodity information and total amount, mobile terminal 1 is initialized and stands by to read a subsequent commodity.

If both of barcode 9 and RF tag 8 are attached to the commodity in S3, it is determined whether commodity code (A) extracted from barcode 9 conforms to commodity code (B) extracted from RF tag 8 in S4. If (A)=(B), the settlement flag within the memory of RF tag 8 is changed to the “temporarily settled” state in S5. Thereafter, the operations following S7 are performed. If both of barcode 9 and RF tag 8 are attached to the commodity but (A)≠(B), the reading has possibly been made from an RF tag 8 attached to a commodity disposed in the neighbor of the target commodity, not one that has been picked by the customer. In this case, a guide message is displayed on the display section of mobile terminal 1 (S6). For example, the customer operates mobile terminal 1 to read again a commodity code directing mobile terminal 1 toward the vicinity of the commodity. Alternatively, the customer changes his/her position to retry the reading so that only commodity that he or she has picked up can be read.

In the transient time when RF tags have not been attached to all commodities yet, the commodity settlement is to be made using both of or either one of the barcode and RF tag. According to the present embodiment, even in such a transient time the commodity settlement system using an RF tag can be constituted. In addition, since the receiver sensitivity is controllable, the risk that information of the RF tag is read by the third person can be avoided by lowering the sensitivity after the settlement. That is, the possibility that commodities purchased by one are known by others can be reduced.

Moreover, the settlement process for commodities having a barcode and an RF tag can be completed in a short time using a mobile terminal. Besides, the store work of carrying commodities can be alleviated and the workload of store clerks can be thereby reduced. Also, thieves of commodities can be prevented.

Other embodiments based on the principles should be obvious those of ordinary skill in the art. Such embodiments are intended to be covered by the claims.

What is claimed is:

1. A commodity settlement system for making settlement for a commodity carrying an RF tag displayed on a commodity shelf, comprising:
an RF tag attached to the commodity, comprising a capacitor, a rectifier circuit, a memory, and an antenna, the RF tag being provided to charge the capacitor with a direct current converted by the rectifier circuit from a current induced in the antenna by receiving a radiowave from an external device, the RF tag storing temporary settlement information in the memory;
a communication device receiving data associated with the commodity stored in the RF tag; and
a first RF tag reader/writer connected to an antenna provided on the commodity shelf, for setting settlement information in the memory to information in an unsettled state through the antenna at intervals of a predetermined time.

2. The commodity settlement system according to claim 1, further comprising a mobile terminal having a barcode reader and a second RF tag reader/writer, the mobile terminal being capable of receiving data associated with the commodity from the commodity carrying RF tag and a barcode by communicating with RF tag and reading the barcode,
wherein the barcode reader reads barcode information attached to the commodity and the second RF tag reader/writer rewrites the temporary settlement information in the memory of the RF tag attached to the commodity.

3. The commodity settlement system according to claim 1, further comprising a third RF tag reader/writer, which causes the RF tag to discharge electricity from a capacitor provided in the RF tag after settlement for the commodity is completed.

4. The commodity settlement system according to claim 1, further comprising a third RF tag reader/writer, a second antenna connected to the third RF tag reader/writer, and an alarm device, wherein third RF tag reader/writer communicates with the RF tag through the second antenna, and the commodity settlement system activates the alarm device if the commodity settlement system recognizes that the temporary settlement information is in an unsettled state, and lowers receiver sensitivity of the RF tag if the commodity settlement system recognizes that the temporary settlement information is in a settled state.

5. The commodity settlement system according to claim 1, further comprising a third RF tag reader/writer, a second antenna connected to the third RF tag reader/writer, and a gate equipped with an alarm device, wherein the third RF tag reader/writer communicates with the RF tag through the second antenna, and the gate with an alarm device activates the alarm device if the gate with an alarm device recognizes that the temporary settlement information is in an unsettled state, and lowers receiver sensitivity of the RF tag if the gate with an alarm device recognizes that the temporary settlement information is in a settled state.

6. The commodity settlement system according to claim 1, further comprising a third RF tag reader/writer, a second antenna connected to the third RF tag reader/writer, and a gate equipped with an alarm device, wherein the third RF tag reader/writer communicates with the RF tag through the second antenna, and the gate with an alarm device activates the alarm device if the gate with an alarm device recognizes that the temporary settlement information is in an unsettled state, and causes the RF tag to discharge electricity from the capacitor provided in the RF tag if the gate unit with an alarm device recognizes that the temporary settlement information is in a settled state.

7. A mobile terminal receiving data associated with a commodity from the commodity having a barcode and the RF tag including a capacitor, a rectifier circuit, a memory, and an antenna, the RF tag being provided to charge the capacitor with a direct current converted by the rectifier circuit from a current induced in the antenna by receiving a radiowave from an external device, the mobile terminal comprising:
a barcode reader reading barcode information attached to the commodity; and
an RF-tag reader/writer capable of rewriting temporary settled information retained in the memory of the RF tag attached to the commodity.

8. The mobile terminal according to claim 7, wherein, when a commodity code of the RF tag read by the RF-tag reader/writer conforms to a commodity code by a barcode read by the barcode reader, the RF-tag reader/writer sets the temporary settlement information to a temporarily settled state.

9. The mobile terminal according to claim 7, comprising a radio communication part capable of receiving price information of the commodity.

10. A method of processing settlement for a commodity disposed on a commodity shelf, the commodity carrying an RF tag, comprising:
disposing a commodity to which the RF tag is attached, the RF tag comprising a capacitor, a rectifier circuit, a memory, and an antenna, the RF tag being provided to charge the capacitor with a direct current converted by the rectifier circuit from a current induced in the antenna by receiving a radiowave from an external device, the RF tag storing temporary settlement information in the memory;
transmitting a continuous wave and a signal from an antenna provided on the commodity shelf;
charging the capacity by the continuous wave; and
rewriting the temporary settlement information in the memory of the RF tag to information in an unsettled state according to the signal at intervals of a predetermined time.

11. The method according to claim 10, further comprising
extracting a commodity code by means of the RF tag from the RF tag by communicating with the RF tag of the commodity having a barcode and the RF tag;
reading the barcode attached to the commodity and extracting a commodity code by means of the barcode; and
rewriting the temporary settlement information in the memory of the RF tag attached to the commodity, if the commodity code by means of the RF tag conforms to the commodity code by means of the barcode.

12. The method according to claim 10, after completion of commodity settlement, electricity is discharged from the capacitor provided in the RF tag.
